(19) United States
(12) Patent Application Publication
(10) Pub. No.: US 2009/0061139 A1
(43) Pub. Date: Mar. 5, 2009

(54) ADHESIVE SHEET

(75) Inventor: Akira DANGAMI, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: LINTEC CORPORATION, Tokyo (JP)

(21) Appl. No.: 12/198,463

(22) Filed: Aug. 26, 2008

(30) Foreign Application Priority Data
Aug. 28, 2007 (JP) 2007-220872

(51) Int. Cl. B32B 33/00

(52) U.S. Cl. 428/42.1

(57) ABSTRACT

An adhesive sheet S includes a first sheet S1 having a first sheet base 10 of which one surface is formed as a printable surface 10A to be printed with mirror letters 10a, a first pseudo-adhesive layer 11 and a first adhesive layer 12 which are laminated on the other surface; and a second sheet S2 having a second sheet base 15 of which one surface is formed as a printable surface 15A to be printed with print letters 15a, a second pseudo-adhesive layer 16 and a second adhesive layer 17 which are laminated on the other surface. The mirror letters 10a maintain in a concealed state under a condition that the second sheet base 15 is peeled off, and the mirror letters 10a become visible in correct orientation seen from the back surface side by peeling off the first sheet base 10, therefore, when the invention is applied to a delivery slip and the like, by arranging the mirror letters 10a to be confidential information, secrecy of the confidential information can be secured.

### BACKGROUND OF THE INVENTION

1. Field of the Invention

The present invention relates to an adhesive sheet, and more particularly to an adhesive sheet capable of attaching to an adherend with confidential information concealed.

2. Description of the Related Art

Recently, with the universal spread of Internet shopping, TV shopping, and the like, mail-order sales have become popular in addition to traditional over-the-counter sales, and a distribution system by delivery companies to deliver products to consumers on behalf of sellers has been increasingly common. Consequently, leaks of information about the products such as the product name and price may be caused through the delivery slips. These information identify the products bought by the consumers, therefore such information are confidential information greatly concerning privacy of the consumers. Also from the perspective of discouraging theft during the course of distribution, they should be confidential information because the product value can be figured out from the product price.

A delivery slip is disclosed in the patent document 1. The delivery slip includes a first slip which is provided with print letters on the front surface and an adhesive layer is provided on the back surface, and a second slip which is pseudoly adhered to the first slip and is provided with print letters on the front surface.

Patent Document 1: Japanese Patent Application Laid-Open No. 2003-11551

### SUMMARY OF THE INVENTION

However, the delivery slip disclosed in the patent document 1 has a disadvantage, nevertheless information printed on the first slip can be partially concealed by the second slip, when the second slip is peeled off from the first slip, the contents printed on the first slip is to be exposed, thus secrecy of information cannot be secured.

The present invention has been made in view of the above disadvantage, and its object is to provide an adhesive sheet capable of certainly securing secrecy of confidential information printed on a delivery slip when the present invention is applied to the delivery slip and the like.

To achieve the above object, the present invention adopts such an arrangement that an adhesive sheet includes: a first sheet of which one surface of a transparent first sheet base is formed as a printable surface to be printed with mirror letters, and the other surface is laminated with a first pseudo-adhesive layer and a first adhesive layer; and a second sheet of which one surface of a transparent or opaque second sheet is formed as a printable surface to be printed with print letters, and the other surface is laminated with a second pseudo-adhesive layer and a second adhesive layer; wherein

the mirror letters are maintained in a concealed state under both conditions where the first sheet and the second sheet are united by overlapping the first sheet base printed with the mirror letters with the second adhesive layer, and where the second sheet base is peeled off.

And, in the present invention, such an arrangement may be adopted that, when the second sheet is overlapped with the first sheet base, an opaque layer is located between the peeling interface of the second pseudo-adhesive layer and the first sheet base.

Also, such an arrangement may be adopted that the second sheet base is opaque and is provided with a cutting-line capable of plurally dividing the second sheet base.

The pseudo-adhesive layer in the present invention may be arranged with a plurality of films, for example, a two-layered laminated film, and they may be detachably provided at their interface. As for the films to be used for the pseudo-adhesive forming layers, such as polyethylene resin, polystyrene resin, acrylic resin, natural rubber-base resin, vinyl chloride-vinyl acetate copolymer, ethylene-vinyl acetate copolymer, UV-curable varnish, and polyethylene terephthalate resin can be exemplified, and the laminated films optionally combined with them may become the pseudo-adhesive layer.

Also, in the present invention, “print letters” is used as a concept including characters, symbols, graphics, or their optional combinations; “transparent” includes semi-transparent; and “opaque” includes objects having concealment performance.

According to the present invention, the second sheet base is peeled at the second pseudo-adhesive layer. Therefore, when an opaque layer is arranged to be located between the peeling interface of the second pseudo-adhesive layer and the first sheet base, information printed on the first sheet base cannot be seen even when peeling off the second sheet base. And, because the information printed on the first sheet base is arranged to be mirror letters, the information become visible seen from the back surface side of the first sheet base (first pseudo-adhesive layer side) by peeling off the first pseudo-adhesive layer. Thus, when the adhesive sheet according to the present invention is applied to a delivery slip, the second sheet base is printed with information having no inconveniency to be displayed such as “sender” and “destination”, and is provided with a column for the receipt stamp of the recipient and the like, so that the delivery person peels off the second sheet base to bring it back, whereby confidential information printed on the first sheet base such as “product name” and “price” are maintained in a concealed state, as long as the recipient does not peel it off at the first pseudo-adhesive layer. Also, the recipient can file the sheet peeled off at the first pseudo-adhesive layer similarly to a paper invoice or proof of purchase because no adhesive is exposed thereon.

Further, since the first sheet and the second sheet have basically the same layered structure, the cost can be held down, and the sheets themselves can be arranged to have no much difference in thickness, whereby setting of a printing means to print on the respective sheets, such as a printer, can be performed in the same setting, therefore also mechanical performance becomes enhanced.

Furthermore, when the second sheet base is arranged to be opaque and is provided with a cutting-line capable of plurally dividing the second sheet base, by printing the mirror letters on the first sheet base within a position away from the area to be cut out to bring it back, the film layer on the second adhesive layer side in the second pseudo-adhesive layer may be transparent, whereby the second pseudo-adhesive layer can be arranged similarly to the first pseudo-adhesive layer.

### BRIEF DESCRIPTION OF THE DRAWINGS

FIG. 1 is a perspective view schematically showing an embodiment of a delivery slip to which an adhesive sheet according to the present invention is applied.

FIG. 2 is an exploded side view showing a layered structure of the adhesive sheet.

FIG. 3 is a perspective view schematically showing a peeling state of the second sheet base.

FIG. 4 is a perspective view schematically showing a peeling state of the first sheet base.

FIG. 5 is a perspective view schematically showing an alternative example similar to FIG. 1.

FIG. 6 is an exploded side view of FIG. 5.

### DETAILED DESCRIPTION OF THE PREFERRED EMBODIMENT

Hereinafter, an embodiment of the present invention will be described with reference to the accompanying drawings.

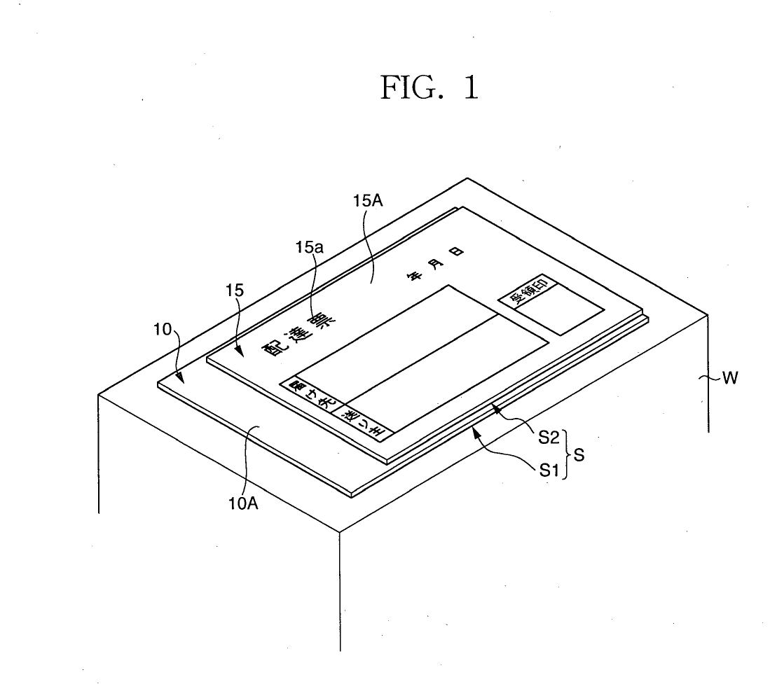

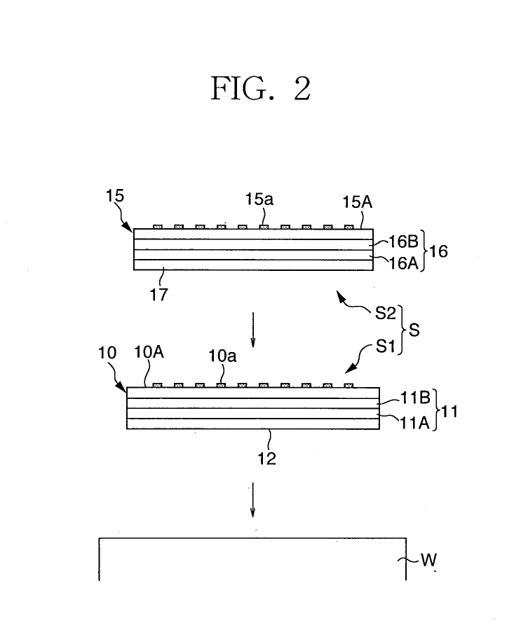

FIG. 1 shows a schematic perspective view of an embodiment of a delivery slip of a product via home-delivery and the like to which an adhesive sheet S according to the present invention is applied, and FIG. 2 shows an exploded side view thereof. In these drawings, an adhesive sheet S is stuck to an adherend W to be a package of a product via home-delivery and the like. The adhesive sheet S includes a first sheet S1 having a substantially square plane shape, and a second sheet S2 having a substantially square plane shape which is smaller than that of the first sheet S1.

As shown in FIG. 2, the first sheet S1 includes a transparent first sheet base 10 of which one surface (upper surface) is formed as a printable surface 10A to be printed with mirror letters 10a, and of which the other surface(lower surface) is sequentially laminated with a first pseudo-adhesive layer 11 and a first adhesive layer 12 which is to be stuck to an adherend W to be a package of a product via delivery services and the like. The first pseudo-adhesive layer 11 includes a first film layer 11A made up of polystyrene, and a second film layer 11B made up of low-density polyethylene which is located on the upper surface side of the first film layer 11A, being detachable at the interface between these first and second film layers 11A and 11B. Here, in the embodiment, the mirror letters 10a are printed with confidential information including, for example, product name and price, and the like, so as to function as an invoice of a delivery product so that the mirror letters 10a become visible in correct orientation seen from the back surface side when the first sheet base 10 is peeled off at the interface between the first and the second film layers 11A and 11B. In this regard, as for the first sheet S1, a release liner (not shown) is temporarily stuck on the first adhesive layer 12 side.

The second sheet S2 includes an opaque second sheet base 15 of which one surface (upper surface) is formed as a printable surface 15A to be printed with print letters 15a, a second pseudo-adhesive layer 16 which is sequentially laminated on the other surface (lower surface) of the second sheet base 15, and a second adhesive layer 17 which is to be stuck to the first sheet base 10 so as to be overlapping therewith. The second pseudo-adhesive layer 16 includes, similarly to the first pseudo-adhesive layer 11, a third film layer 16A made up of polystyrene, and a fourth film layer 16B made up of low-density polyethylene which is located on the upper surface side of the third film layer 16A, being detachable at the interface between these third and fourth film layers 16A and 16B. Here, the third film layer 16A is provided in opaque so that even when the second sheet base 15 is peeled off at the interface between the third and fourth film layers 16A and 16B, the mirror letters 10a printed on the first sheet base 10 are not visible through the third film layer 16A. And, the print letters 15a of the second sheet base 15 is arranged, in the embodiment, to be printed with indications, for example, “destination” and “sender” and the like of the delivery product, and also a column for a “receipt stamp”, so that a delivery person peels off the second sheet base 15 to bring it back. In this regard, as for the second sheet S2, a release liner (not shown) is temporarily stuck on the second adhesive layer 17 side.

Next, usage of the adhesive sheet S in accordance with the embodiment will be described.

To begin with, in the first sheet S1, the printable surface 10A of the first sheet base 10 is printed with the mirror letters 10a as the confidential information described above. On the other hand, in the second sheet S2, the printable surface 15A of the second sheet base 15 is printed with print letters 15a such as a recipient name.

Peel off the release liner (not shown) in the second sheet S2 to expose the second adhesive layer 17, and then stick the second sheet S2 to the first sheet S1 through the second adhesive layer 17 to unite the two into one adhesive sheet S.

Next, peel off the release liner (not shown) which is temporarily stuck with the first adhesive layer 12 in the first sheet S1 to expose the first adhesive layer 12, and then stick the adhesive sheet S to the adherend W through the first adhesive layer 12.

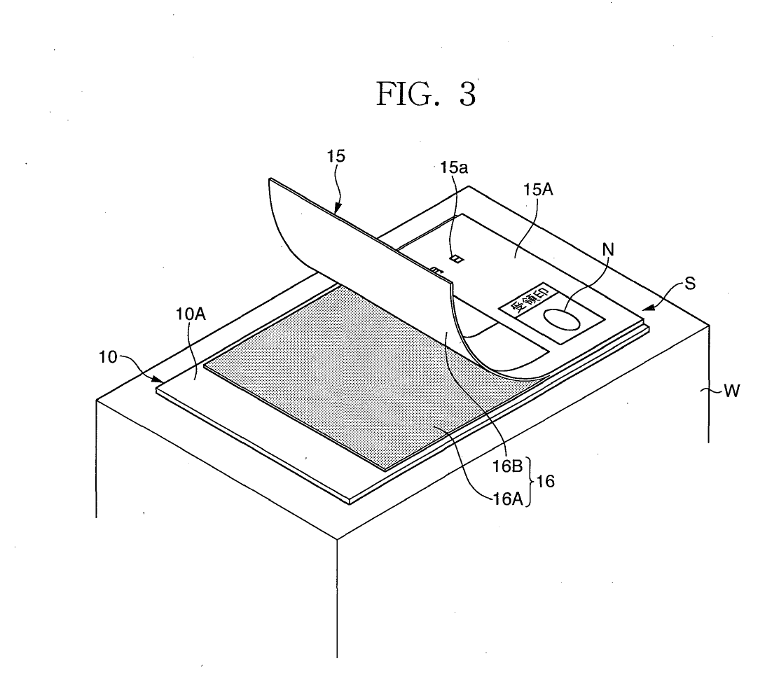

When a product via home-delivery attached with the adhesive sheet S is delivered to a recipient, as shown in FIG. 3, the delivery person receives the stamp N as the signet of the recipient on the column for the receipt stamp in the second sheet base 15, and then peels of f the second sheet base 15 to bring back the second sheet base 15. The peeling-off is performed at the interface between the third and fourth film layers 16A and 16B described above. In this regard, the third film layer 16A is left on the first sheet S1 through the second adhesive layer 17, however, the mirror letters 10a on the first sheet base 10 are not seen through because the third film layer 16A is opaque.

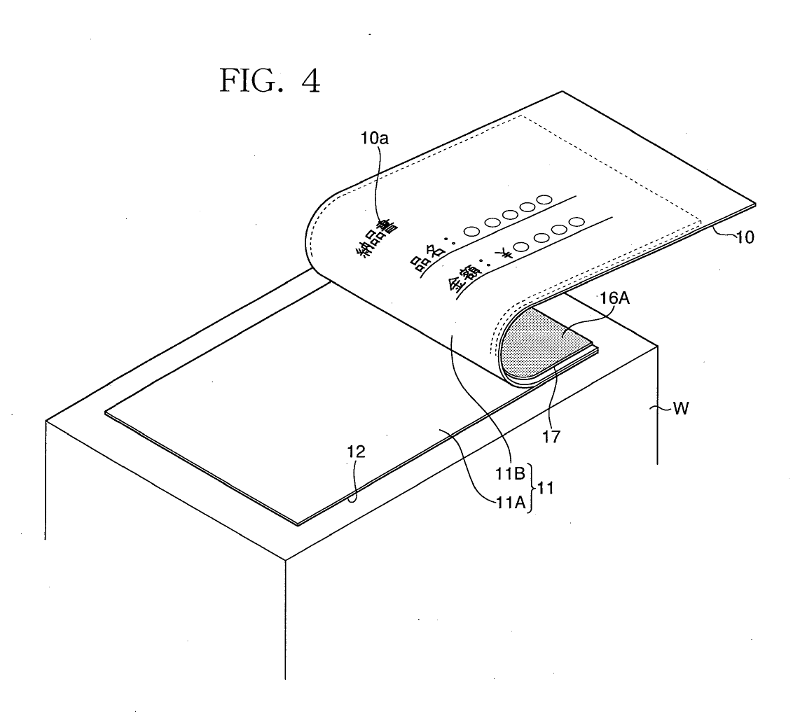

As shown in FIG. 4, the recipient peels off the first sheet base 10, whereby the mirror letters 10a become visible in correct orientation seen from the back surface side, and the first sheet base S1 can be filed as a sheet piece with no adhesive exposed. The peeling-off of the first sheet base 10 is performed at the interface between the first film layer 11A and the second film layer 11B, and the first adhesive layer 12 and the first film layer 11A are to be left on the adherend W.

Therefore, according to the embodiment as described above, even the delivery person cannot see the contents of the mirror letters 10a printed on the printable surface 1OA of the first sheet base 10. Thus, an adhesive sheet which can securely protect personal privacy can be provided by using it as a delivery slip for mail-order sales and the like.

Further, the first sheet base 10 and the second sheet base 15 can be peeled off respectively between the layers of the first pseudo-adhesive layer 11 and of the second pseudo-adhesive layer 16, that makes the peeling-off easier.

The best arrangement, method and the like for carrying out the present invention have been disclosed so far. However, the present invention is not limited to the above.

That is, the present invention has been illustrated and described mainly about a specific embodiment. However, it is possible for those skilled in the art to add various modifications, if necessary, to the above-described embodiment with respect to the shape, position and/or disposition without departing from the technical spirit and the range of the object of the present invention.

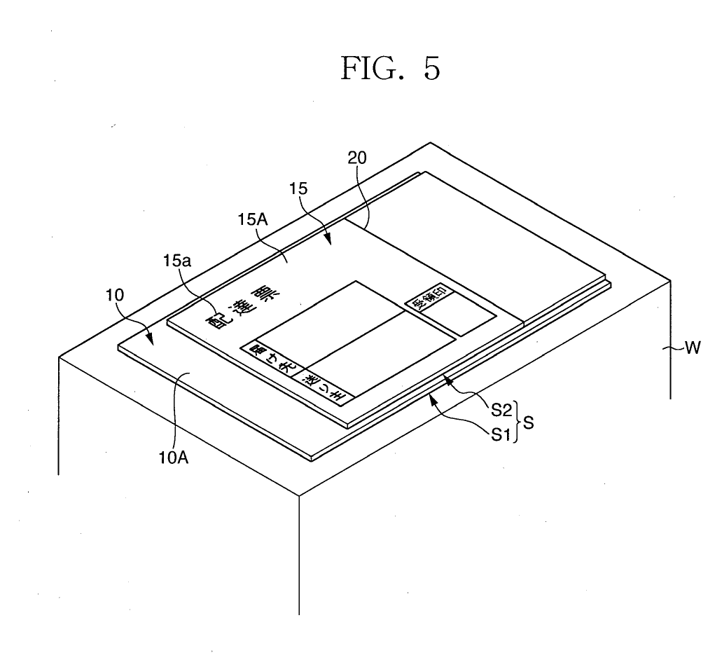

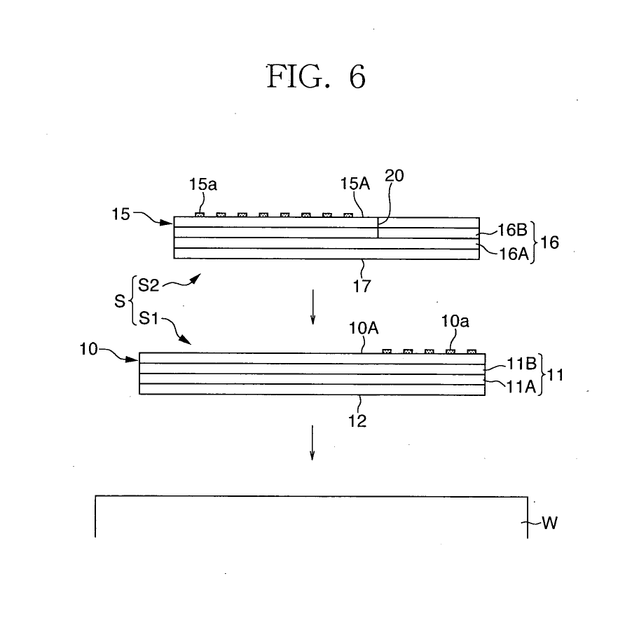

For example, as shown in FIG. 5 and FIG. 6, a cutting-line 20 which is capable of plurally dividing the second sheet base 15 may be provided so that the delivery person brings back the left-side area of the cutting-line 20 in the figure. In this instance, when the mirror letters 10a are printed on the first sheet base 10 within the right-side area of the cutting-line 20 in the figure, the third film layer 16A is not required to be formed in opaque, and the second pseudo-adhesive layer 16 can be arranged in the same structure as the first pseudo-adhesive layer 11.

And, in the embodiment above, a case where the second sheet base 15 is opaque has been described, however, the second sheet base 15 may be transparent as long as the second film layer 16A or the second adhesive layer 17 is opaque.

Also, number of layers in the adhesive sheet S according to the present invention is not limited to the illustrated arrangement example, and the layers may be increased and decreased as necessary, as long as it has the similar effects.

Further, in the embodiment above, the third film layer 16A is formed to be opaque so that the mirror letters 10a printed on the first sheet base 10 are not seen through, however, it also may be arranged to provide an additional opaque layer between the peeling interface of the second pseudo-adhesive layer and the first sheet base 10 so that the mirror letters 10a are not seen through.

Furthermore, the adhesive sheet S may be applied, not limited to the delivery slip of the product via home-delivery, but also to other labels and the like on which confidential information are required to be concealed without leaking out, and also, various changes such as the planar shape of the adhesive sheet S, and the relative plane area between the first and the second sheet S1 and S2, may be made as long as the confidential information can be concealed.

Still further, a cutout, a cutting-line, a tab, or the like may be provided to make the incipient peeling-off of the first sheet base 10 and the second sheet base 15 easier.

What is claimed is:

1. An adhesive sheet, comprising:
a first sheet of which one surface of a transparent first sheet base is formed as a printable surface to be printed with mirror letters, and the other surface is laminated with a first pseudo-adhesive layer and a first adhesive layer; and a second sheet of which one surface of a transparent or opaque second sheet is formed as a printable surface to be printed, and the other surface is laminated with a second pseudo-adhesive layer and a second adhesive layer; wherein
the mirror letters are maintained in a concealed state under both conditions where the first sheet and the second sheet are united by overlapping the first sheet base printed with the mirror letters with the second adhesive layer, and where the second sheet base is peeled off.

2. The adhesive sheet according to claim 1, wherein, when the second sheet is overlapped with the first sheet base, an opaque layer is arranged to be located between the peeling interface of the second pseudo-adhesive layer and the first sheet base.

3. The adhesive sheet according to claim 1, wherein the second sheet base is opaque and is provided with a cutting-line capable of plurally dividing the second sheet base.
